(19) United States
(12) Patent Application Publication
(10) Pub. No.: US 2002/0048988 A1
(43) Pub. Date: Apr. 25, 2002

(54) Press-connecting terminal

(75) Inventors: Yoshitsugu Sawada, Shizuoka (JP); Takuya Hasegawa, Shizuoka (JP)

Correspondence Address: SUGHRUE, MION, ZINN,, MACPEAK & SEAS, PLLC, 2100 Pennsylvania Avenue, N.W., Washington, DC, 20037, US

(73) Assignee: YAZAKI CORPORATION

(21) Appl. No.: 09/981,714

(22) Filed: Oct. 19, 2001

(30) Foreign Application Priority Data
Oct. 19, 2000 (JP) P.2000-319691

(51) Int. Cl. H01R 4/24

(52) U.S. Cl. 439/397

(57) ABSTRACT

A press-connecting terminal (1) includes an electrical contact portion (2), a wire press-connecting portion (3) and a wire clamping portion (4), which are integrally formed. A wall thickness of the wire press-connecting portion (3) is greater than a wall thickness of the electrical contact portion (2) and a wall thickness of the wire clamping portion (4). The electrical contact portion (2) includes a thin bottom plate portion, a thin peripheral wall portion (5) integrally formed with the bottom plate portion, and a thin resilient contact piece portion which is disposed within the peripheral wall portion (5). The wire press-connecting portion (3) includes a thick bottom plate portion, thick side plate portions (12) extending upwardly from opposite side edges of the bottom plate portion, and thick press-connecting piece portions (17, 18) projecting inwardly from edges of window portions (16) formed through the side plate portions (12).

### BACKGROUND OF THE INVENTION

1. Field of the Invention

The present invention relates to a press-connecting terminal in which only a wire press-connecting portion is thickened to have an increased rigidity, thereby enhancing the reliability of the press-connection.

The present application is based on Japanese Patent Application No. 2000-319691, which is incorporated herein by reference.

2. Description of the Related Art

FIGS. 7 to 12 show a related press-connecting terminal.

As shown in FIGS. 7 and 8, this press-connecting terminal 41 includes an electrical contact portion 43 of a female type, formed at one end portion of a base plate portion 42, and also includes a wire press-connecting portion 44 and a wire clamping portion 45 which are formed at the other end portion of the base plate portion 42.

The female electrical contact portion 43 is formed into a square tubular shape, and has a resilient contact piece portion (contact spring piece portion) 47 which is formed integrally therewith, and is provided within a peripheral wall 46. The resilient contact piece portion 47 extends from a front end of the base plate portion 42, and is curved within an internal space 48 of the peripheral wall 46. A convex contact portion 50 is formed on a top plate portion 49 of the peripheral wall 46, and projects toward the resilient contact piece portion 47. When a male tab (electrical contact portion) of a mating terminal (not shown) is inserted between the convex contact portion 50 and the resilient contact piece portion 47, and is connected thereto, the resilient contact piece portion 47 is resiliently deformed toward the base plate portion 42, thereby assuring a pressure of contact with the male tab.

The wire press-connecting portion 44 extends rearwardly from the female electrical contact portion 43 through notches 51. The wire press-connecting portion 44 includes a pair of side plate portions 52, extending upwardly respectively from opposite side edges of the base plate portion 42, window portions 53 each formed through a central portion of the corresponding side plate portion 52, a pair of press-connecting piece portions 54, projecting inwardly respectively from front edges of the window portions 53, and another pair of press-connecting piece portions 55 projecting inwardly respectively from rear edges of the window portions 53.

Each pair of press-connecting piece portions 54, 55 are formed by bending the relevant portions of the side plate portion 52 inwardly substantially perpendicularly simultaneously when forming the window portion 53 by stamping. Each pair of right and left press-connecting piece portions 54, 55, formed respectively at the front and rear edges of the window portion 53, are disposed at a predetermined interval in opposed relation to each other. Here, the term “front and rear” means the longitudinal direction of the terminal, and “the front side” means that side where the electrical contact portion 43 is provided, and “the rear side” means that side where the wire clamping portion 45 is provided.

The gap between the two pairs of right and left press-connecting piece portions 54 and 55 is slightly smaller than a diameter of a conductor portion 21 (FIG. 9) of an insulating sheathed wire (hereinafter referred to merely as “wire”) 20 which is to be press-connected to the terminal. A tapering (slanting) blade portion 56 is formed on a shoulder portion of each of the press-connecting piece portions 54 and 55.

When the wire 20 is press-fitted into the gap between each pair of right and left press-connecting piece portions 54, 55 by a blade of a press-connecting machine (not shown) as shown in FIGS. 9 and 10, an insulating sheath 22 of the wire 20 is cut by the blade portions 56, and the conductor portion 21 contacts the inner end surfaces of each pair of press-connecting piece portions 54, 55. As a result, the wire 20 is electrically connected to the press-connecting terminal 41.

FIG. 9 is a cross-sectional view taken along the line IX-IX of FIG. 7, showing a condition before the press-connection of the wire, FIG. 10 is a cross-sectional view taken along the line X-X of FIG. 7, showing a condition after the press-connection of the wire, and FIG. 11 is a cross-sectional view taken along the line XI-XI of FIG. 10, showing the condition after the press-connection of the wire.

In FIGS. 7 and 8, a pair of right and left clamping piece portions (press-clamping piece portions) 58 of the wire clamping portion 45 are formed integrally with the rear end of the wire press-connecting portion 44 through notches 57. The clamping piece portions 45 extend upwardly respectively from the opposite side edges of the base plate portion 42, and are continuous and integral respectively with the side plate portions 52 of the wire press-connecting portion 44 through those portions of the terminal disposed respectively below the notches 57.

As shown in FIG. 12, the pair of right and left clamping piece portions 58 are pressed to be curled inwardly after or simultaneously when press-connecting the wire. Distal ends 58a of the clamping piece portions 58 press the insulating sheath 22 of the wire 20 hard against the base plate portion 42. As a result, the wire 20 is prevented from upward withdrawal. And besides, when a rearward pulling force acts on the wire 20, the press-connecting piece portions 54 and 55 are prevented from being bent rearwardly.

Usually, the press-connecting operation and press-clamping operation for the wire 20 are effected after the press-connecting terminal 41 is received in a terminal receiving chamber or a terminal receiving groove in a connector housing (not shown) made of a synthetic resin. In this case, at least that portion of the housing, corresponding to the wire press-connecting portion 44 and wire clamping portion 45 of the press-connecting terminal 41, is open to the exterior, and after the above operations, this opening is closed by stacking a plurality of connector housings together or by attaching a cover to the connector housing.

The press-connecting terminal 41, having the female electrical contact portion 43, is received in a male connector housing, and a male connector, comprising the male connector housing (not shown) and the press-connecting terminal 41, is fitted in a mating female connector (not shown), and a tab-like electrical contact portion of the male terminal within the female connector housing is inserted into the female electrical contact portion 43 of the press-connecting terminal 41, so that the two terminals are connected together. Usually, a plurality of press-connecting terminals 41 are arranged in a juxtaposed manner with the connector housing.

The press-connecting terminal 41 can be suitably used also as a terminal for a joint plate. Such a joint plate is used instead of the connector housing, and a plurality of terminal receiving grooves are formed in a plate body of the joint plate, and are arranged in longitudinal and transverse directions in a matrix manner, and the press-connecting terminal 41 is received and retained in the corresponding terminal receiving groove, and in this condition the wire 20 is press-connected and press-clamped to the terminal, and if necessary, the upper and lower plates are joined together through the connection between the electrical contact portions 43 (The mating electrical contact portion has a male tab-shape). In this case, for example, the box-like electrical contact 43 may be bent downwardly at a right angle relative to the wire press-connecting portion 44.

In the above connector, the female electrical contact portion 43 of the press-connecting terminal 41 may be replaced by a structure having a pair of right and left spring piece portions opposed to each other in a generally spectacles-shape.

In the press-connecting terminal 41 as has been described above, however, the electrical contact portion 43, the wire press-connecting portion 44 and the wire clamping portion 45 are formed by an electrically-conductive metal material having a uniform wall thickness. Therefore, when the wall thickness of the electrical contact portion 43 is reduced in order to achieve a low insertion force design (so as to enhance the efficiency of the connecting operation when inserting the mating male terminal into this electrical contact portion) and a compact design of the electrical contact portion 43, the wall thickness of the wire press-connecting portion 44 is also reduced, and there has been encountered a problem that the wire contact load and wire holding force of the left and right press-connecting piece portions 54 and 55 are reduced, so that the reliability of the electrical connector is lowered.

Namely, in FIGS. 9 to 11, when the wire 20 is press-fitted into the gap between each pair of right and left press-connecting piece portions 54, 55, each of the right and left side plate portions 52 is liable to be flexed (or bent) to be turned outwardly (as indicated by arrow M) about a region of intersection of this side plate portion 52 and the base plate portion 42, and therefore the distance between each pair of right and left press-connecting piece portions 54, 55 increases. This has invited a problem that the load of contact (i.e., pressure of contact) of the conductor portion 21 with the press-connecting piece portions 54 and 55 after the press-connection of the wire is lowered.

When a large rearward pulling force is applied to the wire 20, each of the right and left press-connecting piece portions 54, 55 is liable to be flexed (or bent) to be turned rearwardly about a region of intersection of this press-connecting piece portion and the side plate portion 52, since the wire clamping portion 45 is thin, and has the relatively-low clamping force. Therefore, there has been a possibility that the press-connecting piece portions 54 and 55 are plastically deformed in this flexed condition, so that the contact of these press-connecting piece portions with the wire 20 is adversely affected, and in the worst case, the wire 20 is disengaged from the terminal.

When the wall thickness of the clamping piece portions 58 is increased in order to increase the strength of the wire clamping portion 45, the wall thickness of the electrical contact portion 43 is also increased, so that the force of insertion of the mating terminal increases, thus adversely affecting the terminal connecting operation. Particularly when many press-connecting terminals 41 are used, the connector fitting force increases, so that the two connectors can not be fitted together by a manual operation, and besides the resilient contact piece portion 47 can not be bent into the required shape. Further, as shown in FIG. 13, a clamping height h₂ of each clamping piece portion 59 is larger than a clamping height h₁ of the existing press-connecting terminal 41 of FIG. 12, which has invited a problem that the dimension of the connecting structure (that is, the connector) in the direction of the height thereof increases.

### SUMMARY OF THE INVENTION

With the above problems in view, it is an object of the present invention to provide a press-connecting terminal in which the force of insertion of a mating terminal into this press-connecting terminal is reduced, and an electrical contact portion and a wire clamping portion can be made compact in size, and a wire can be press-connected to the terminal with a large contact load, and even when a large pulling force acts on the wire, the deformation of press-connecting piece portions and the disengagement of the wire will not occur, and the reliability of press-connection of the wire can be enhanced.

To achieve the above object, according to a first aspect of the present invention, there is provided a press-connecting terminal which comprises a wire press-connecting portion to which a wire is connectable, and an electrical contact portion, to which a mating terminal is connectable, integrally formed with a first end of the wire press-connecting portion, wherein a wall thickness of the wire press-connecting portion is greater than a wall thickness of the electrical contact portion.

According to a second aspect of the present invention, it is preferable that the electrical contact portion includes a thin bottom plate portion, a thin peripheral wall portion integrally formed with the thin bottom plate portion, and a thin resilient contact piece portion which is disposed within the thin peripheral wall portion, and is integrally formed with the thin bottom plate portion.

According to a third aspect of the present invention, it is preferable that the wire press-connecting portion includes a thick bottom plate portion, thick side plate portions respectively extending upwardly from opposite side edges of the thick bottom plate portion, and thick press-connecting piece portions respectively projecting inwardly from edges of window portions, which are respectively formed through the thick side plate portions.

According to a fourth aspect of the present invention, it is preferable that the press-connecting terminal further comprises a wire clamping portion integrally formed with a second end of the wire press-connecting portion remotely from the electrical contact portion, wherein the wall thickness of the wire press-connecting portion is greater than a wall thickness of the wire clamping portion.

According to a fifth aspect of the present invention, it is preferable that the wire clamping portion includes a thin bottom plate portion, and thin clamping piece portions respectively extending upwardly from opposite side edges of the thin bottom plate portion.

### BRIEF DESCRIPTION OF THE DRAWINGS

The above and other objects and advantages of the present invention will become more apparent by describing in detail a preferred embodiment thereof with reference to the accompanying drawings, wherein:

FIG. 1 is a perspective view of one preferred embodiment of a press-connecting terminal of the present invention;

FIG. 2 is a cross-sectional view of the press-connecting terminal taken along the line II-II of FIG. 1;

FIG. 3 is a cross-sectional view taken along the line III-III of FIG. 1, showing a condition in which a wire is to be press-connected;

FIG. 4 is a cross-sectional view taken along the line IV-IV of FIG. 1, showing a condition in which the wire is press-connected;

FIG. 5 is a cross-sectional view taken along the line V-V of FIG. 4, showing the condition in which the wire is press-connected;

FIG. 6 is a perspective view showing one method of producing the press-connecting terminal;

FIG. 7 is a perspective view of a related press-connecting terminal;

FIG. 8 is a cross-sectional view of the related press-connecting terminal taken along the line VIII-VIII of FIG. 7;

FIG. 9 is a cross-sectional view taken along the line IX-IX of FIG. 7, showing a condition in which a wire is to be press-connected to the related press-connecting terminal;

FIG. 10 is a cross-sectional view taken along the line X-X of FIG. 7, showing a condition in which the wire is press-connected to the related press-connecting terminal;

FIG. 11 is a cross-sectional view taken along the line XI-XI of FIG. 10, showing the condition in which the wire is press-connected to the related press-connecting terminal;

FIG. 12 is a vertical cross-sectional view showing a condition in which the wire is press-clamped to a wire clamping portion of the related press-connecting terminal; and

FIG. 13 is a vertical cross-sectional view showing a problem encountered when a wire clamping portion is thickened.

### DETAILED DESCRIPTION OF THE PREFERRED EMBODIMENT

A preferred embodiment of the present invention will now be described in detail with reference to the drawings.

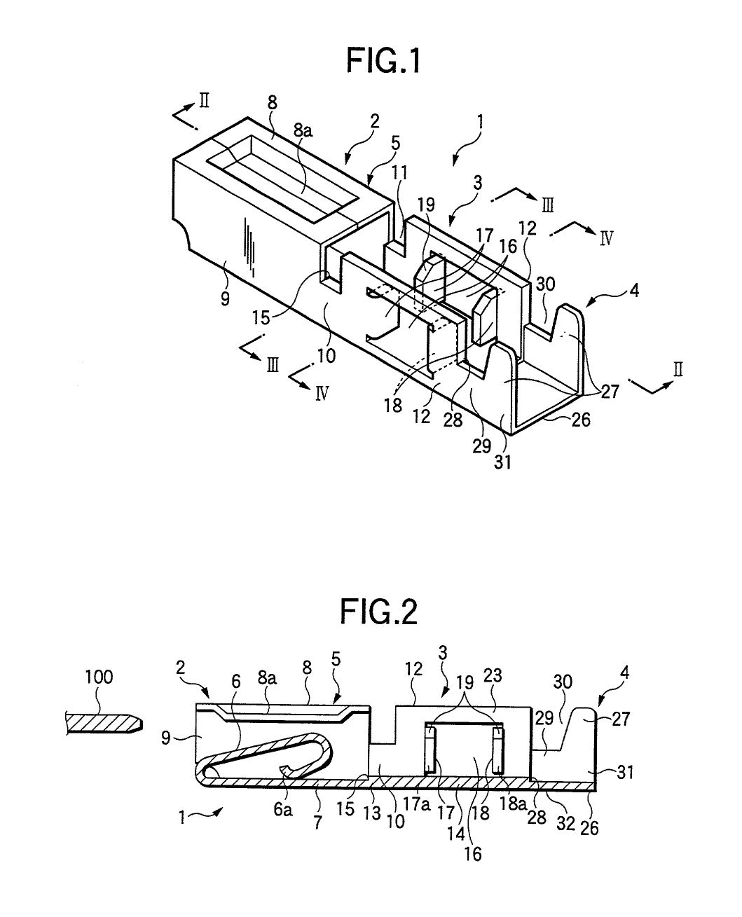

FIGS. 1 to 5 show one preferred embodiment of a press-connecting terminal of the present invention.

As shown in FIGS. 1 and 2, this press-connecting terminal 1 includes a thin (thin-wall) electrical contact portion 2 formed at one end portion thereof, and also includes a thick (thick-wall) wire press-connecting portion 3 and a thin (thin-wall) wire clamping portion 4 which are formed at the other end portion thereof.

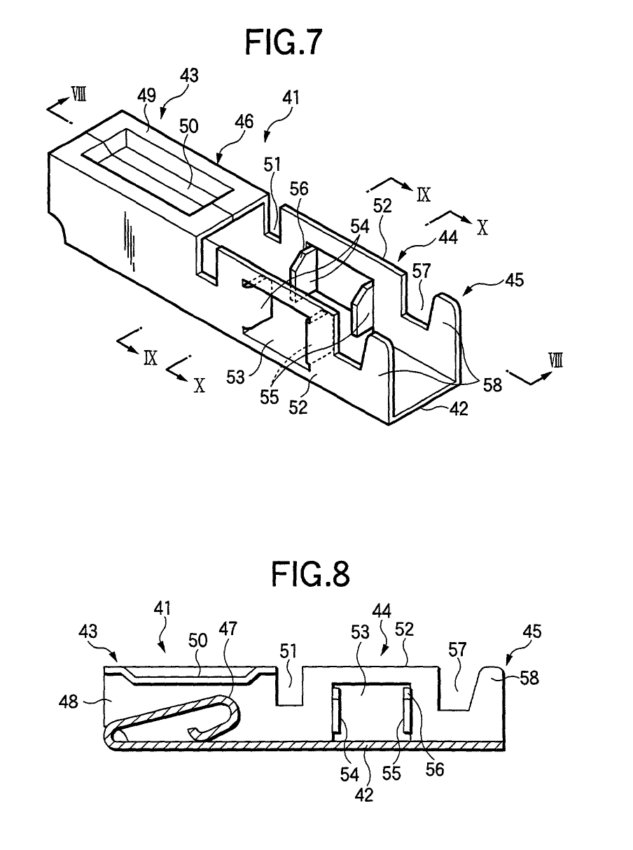

The electrical contact portion 2 has a wall thickness which is equal to or smaller than the wall thickness of the electrical contact portion that has been shown in FIG. 7. This electrical contact portion 2 includes a peripheral wall 5 of a square tubular 25 shape, and a resilient contact piece portion 6 (FIG. 2) provided within the peripheral wall 5. A bottom plate portion 7 (FIG. 2) of the peripheral wall 5 forms part of a base plate portion of the terminal extending in a longitudinal direction thereof, and a top plate portion 8 has a convex contact portion 8a disposed in opposed relation to the resilient contact piece portion 6. The peripheral wall 5 (that is, the bottom plate portion 7, the top plate portion 8 and right and left side plate portions 9) and the resilient contact piece portion 6, extending in a curved manner from a front end of the bottom plate portion 7 into the peripheral wall 5, have the same wall thickness, and are thin.

Preferably, the resilient contact piece portion 6 is formed into a thickness which is minimum and necessary for obtaining a sufficient contact pressure of the resilient contact piece portion 6 with a male tab (electrical contact portion) of a mating terminal 100. With this construction, the force of insertion of the mating terminal 100 is reduced, and the operation for connecting the terminals together, as well as the operation for fitting the connectors together, can be easily effected with a low force. When forming the thin-wall electrical contact portion 2, preferably, the resilient contact piece portion 6 is formed into a slightly volute shape as shown in FIG. 2, and a curved distal end 6a of the resilient contact piece portion 6 is contacted with and supported on the bottom plate portion 7 so as to produce a sufficient resilient force.

The electrical contact portion 2 is continuous and integral with the thick-wall wire press-connecting portion 3 (disposed rearwardly of this electrical contact portion) through a notched interconnecting portion 10. A notch 11 is formed in each upper edge of the interconnecting portion 10, and the interconnecting portion 10 has a height, for example, about half of the height of the side plate portion 9, and is continuous with side plate portions 12 of the wire press-connecting portion 3. A bottom plate portion 13 (FIG. 2) of the interconnecting portion 10 is thick, and is continuous and integral with a bottom plate portion 14 (FIG. 2) of the wire press-connecting portion 3, and has the same thickness as that of the bottom plate portion 14. A front end of the interconnecting portion 10 is continuous and integral with the rear end of the peripheral wall 5 of the electrical contact portion 2 through a step portion 15.

There can be used an arrangement in which the notched interconnecting portion 10 is not provided, and the side plate portions 9 of the electrical contact portion 2 are extended rearwardly with the uniform height, and are formed integrally with the side plate portions 12 of the wire press-connecting portion 3, respectively. There can be used another arrangement in which the notches 11 are extended to the bottom plate portion 13 (FIG. 2), so that the interconnecting portion 10 is defined only by the bottom plate portion 13. There can be used a further arrangement in which the interconnecting portion 10 is thinned like the electrical contact portion 2, and the rear end of the interconnecting portion 10 is integrally connected to the front end of the wire press-connecting portion 3 through a step portion.

The wire press-connecting portion 3 includes the bottom plate portion 14, which is part (i.e., an intermediate portion in the longitudinal direction) of the base plate portion, the side plate portions 12, extending upwardly respectively from the opposite (right and left) side edges of the bottom plate portion 14, window portions 16 each formed through a generally central portion of the corresponding side plate portion 12, a pair of press-connecting piece portions 17, projecting inwardly respectively from front edges of the window portions 16, and another pair of press-connecting piece portions 18 projecting inwardly respectively from rear edges of the window portions 16. These portions 12, 14, 17 and 18 have the same wall thickness, and are thick. For example, the wall thickness of the wire press-connecting portion 3 is about twice larger than the wall thickness of the electrical contact portion 2 (this is merely one example).

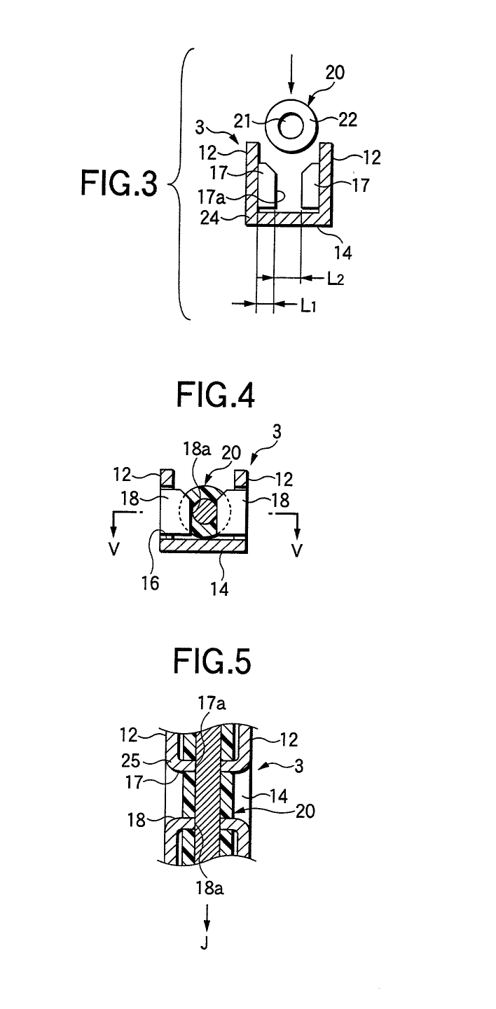

The wire press-connecting portion 3 is made thick, and therefore a sharp blade portion 19 can be formed in a slanting manner on a shoulder portion of each of the press-connecting piece portions 17 and 18 by pressing or the like. An insulating sheath 22 of a wire 20 (FIG. 3) can be positively cut by the sharp slanting blade portions 19 formed respectively on the thick press-connecting piece portions 17 and 18.

Lower edges of the window portions 16 in the wire press-connecting portion 3 are disposed generally flush with the upper surface of the bottom plate portion 14. The upper edge of each window portion 16 is disposed close to the upper edge of the corresponding side plate portion 12. The wall thickness of the side plate portion 12 is large, and therefore even when the thickness of that portion 23 (FIG. 2), lying between the upper edge of the window portion 16 and the upper edge of the side plate portion 12, in the direction of the height is reduced, there is no problem with the strength. Therefore, the height of the press-connecting piece portions 17 and 18 can be made close to the height of the side plate portions 12, and by doing so, the length of the blade portions 19, as well as the height (and length) of inner end surfaces 17a and 18a (FIG. 2) of the press-connecting piece portions 17 and 18, serving as contact surfaces, can be increased.

The press-connecting piece portions 17 and 18 are thick, and therefore even if the two pairs of press-connecting piece portions 17 and 18 are not provided at the front and rear portions, but only one of the two pairs of these press-connecting piece portions are provided at the rear or the front portions, sufficient areas of contact with a conductor portion 21 of the wire 20 (FIG. 3), as well as a sufficient force for holding this conductor portion, can be secured.

The side plate portions 12 of the wire press-connecting portion 3 are thick, and therefore even when the distance between the front edge of each window portion 16 and the front edge of the corresponding side plate portion 12, as well as the distance between the rear edge of the window portion 16 and the rear edge of the side plate portion 12, is reduced, the sufficient strength of the wire press-connecting portion 3 can be secured. Therefore, the length of the wire press-connecting portion 3 between its front and rear ends can be reduced, so that the compact or small-size design of the press-connecting terminal 1 can be achieved.

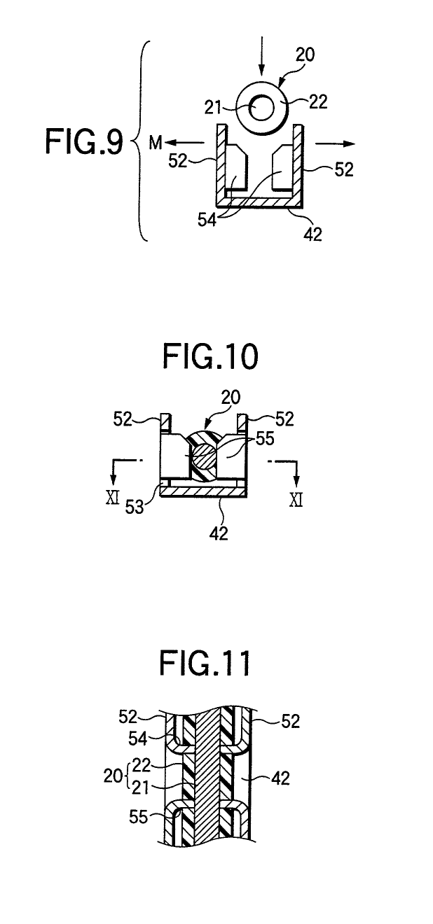

As shown in FIG. 1, the width of the electrical contact portion 2 is equal to the width of the wire press-connecting portion 3, and the thickness of the side plate portions 12 of the wire press-connecting portion 3 is larger as compared with the construction shown in FIG. 7, so that the amount L₁ (FIG. 3) of inward projection of the press-connecting piece portions 17 and 18 is smaller, and the gap L₂ (FIG. 3) between each pair of right and left press-connecting piece portions 17, 18 has the same size as that of the press-connecting terminal that is shown in FIG. 9. The press-connecting piece portions 17 and 18 are thicker and shorter, and therefore the flexural rigidity of the press-connecting piece portions 17 and 18 are markedly increased as compared with the press-connecting terminal shown in FIG. 7.

As shown in FIGS. 3 and 4, the side plate portions 12 and bottom plate portion 14 of the wire press-connecting portion 3 are thicker as compared with the construction shown in FIGS. 9 and 10, and therefore each intersection portion 24 (FIG. 3), at which the corresponding side plate portion 12 and the bottom plate portion 14 intersect each other, is thickened, so that the rigidity of the side plate portion 12 in an outward direction, that is, an opening direction (also in an inward direction, that is, a closing direction) increases. Therefore, when the wire 20 is press-fitted into the gap between each pair of right and left press-connecting piece portions 17, 18, the two side plate portions 12 are not opened outwardly, or are hardly opened outwardly, so that the inner end surfaces 17a and 18a of the press-connecting piece portions 17 and 18 positively contact the conductor portion 21 of the wire 20 with a large contact pressure.

The area of the inner end surfaces 17a and 18a of the press-connecting piece portions 17 and 18 is larger as compared with the construction shown in FIG. 7, and therefore the areas of contact with the conductor portion 21 of the wire 20 increase, so that the conducting resistance of the press-connecting piece portions 17 and 18 is reduced. And besides, the whole of the wire press-connecting portion 3 is larger in thickness than the other portions, and therefore the conducting resistance of the wire press-connecting portion 3 is reduced, and therefore is prevented from being excessively heated.

After the press-connecting operation, each pair of press-connecting piece portions 17, 18 firmly hold the conductor portion 21 of the wire 20 therebetween, and therefore even when an upward withdrawing force (exerted in a direction opposite to the press-connecting direction) acts on the wire 20, the wire 20 will not be withdrawn upwardly. With this construction, even if the provision of the rear-side wire clamping portion 4 is omitted, the sufficient wire-holding force can be secured.

The rigidity of the press-connecting piece portions 17 and 18 in the direction of the height is high, and therefore when the wire 20 is brought into abutting engagement with the blade portions 19 of the press-connecting piece portions 17 and 18 during the wire press-connecting operation, the press-connecting piece portions 17 and 18 will not be buckled and flexed downwardly, so that the blade portions 19 can positively cut the insulating sheath 22 of the wire 20 completely.

Each intersecting portion 25 (FIG. 5), at which the corresponding press-connecting piece portion 17, 18 and the side plate portion 12 intersect each other, is thickened, and therefore the rigidity of each press-connecting piece portion 17, 18 in the direction of the thickness is high. Therefore, even when a large rearward pulling force (indicated by arrow J) acts on the wire 20, press-connected between each pair of press-connecting piece portions 17, 18 as shown in FIG. 5, the press-connecting piece portions 17 and 18 will not be flexed (or bent) in this pulling direction, and the incomplete contact of the wire press-connecting portion 3, as well as the withdrawal of the wire 20 from the press-connecting piece portions 17 and 18, will not occur.

Thus, the side plate portions 12, the press-connecting piece portions 17 and 18 and the bottom plate portion 14 of the wire press-connecting portion 3 are made thicker as compared with the construction shown in FIG. 7, and therefore the strength of press-connection of the wire 20 to the press-connecting piece portions 17 and 18 increases, and the reliability of the electrical connection of the wire press-connecting portion 3 is enhanced. The flexural rigidity of the wire press-connecting portion 3 is made, for example, twice higher than that of the construction shown in FIG. 7, and by doing so, only one of the two pairs of right and left press-connecting piece portions 17 and 18 can be provided (that is, the front press-connecting piece portions 17 or the rear press-connecting piece portions 18 are provided). In this case, the length of the window portions 16 can be reduced, so that the length of the wire press-connecting portion 3 is reduced, and therefore the dimension of the press-connecting terminal 1 in the direction of the length can be reduced.

As shown in FIGS. 1 and 2, the thin-wall wire clamping portion 4 is continuous and integral with the rear end of the thick-wall wire press-connecting portion 3. The wall thickness of the wire clamping portion 4 is equal to the wall thickness of the electrical contact portion 2. The wall thickness of the wire clamping portion 4 can be made smaller or larger than the wall thickness of the electrical contact portion 2.

The wire clamping portion 4 is made smaller in wall thickness at least than the wire press-connecting portion 3, and therefore the clamping operation of the wire clamping portion 4 can be easily effected with a low load, and besides the height of the pressed (or clamped) wire clamping portion 4 is lower as compared with the case where the wire clamping portion has the larger wall thickness as shown in FIG. 13, and therefore the dimension of the press-connecting terminal 1 in the direction of the height can be reduced.

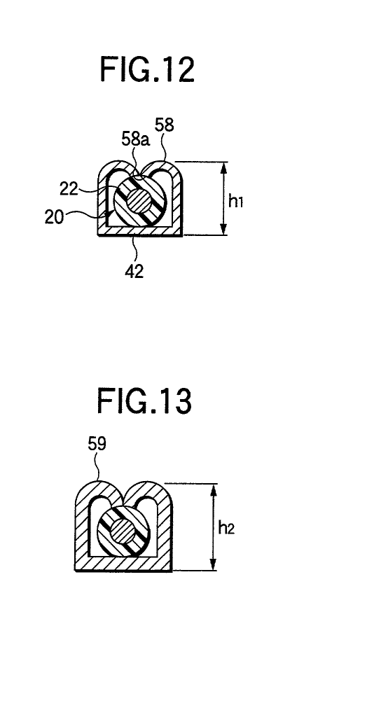

In many cases, usually, the wire clamping portion 4 before the clamping operation is larger in height than the wire press-connecting portion 3 and the electrical contact portion 2 (otherwise, when the wire clamping portion is pressed or clamped as shown in FIG. 12, the distal ends of curled clamping piece portions can not be pressed hard against the upper portion of the wire ). In this case, particularly the dimension of the terminal in the direction of the height increases. The height of the wire clamping portion 4 after the clamping operation must be smaller than the height of a connector housing (not shown) for receiving the press-connecting terminal 1. If the height of the wire clamping portion 4 after the clamping operation is large, the dimension of the connector housing is also increased in the direction of the height. However, such a problem will not be encountered with this embodiment, and terminal receiving chambers or terminal receiving grooves of the connector housing can be kept to a small height, and a compact design of the connector can be achieved.

The rigidity of the wire press-connecting portion 3 is high, and the wire 20 (FIG. 3) can be firmly held by the wire press-connecting portion 3, and the wire clamping portion 4 need only to perform an auxiliary function. Therefore, even when a bottom wall portion 26 (which is part of the base plate portion) of the wire clamping portion 4, and a pair of right and left clamping piece portions 27, extending upwardly respectively from opposite side edges of the bottom plate portion 26, have the same wall thickness, and are considerably thin, there is no problem from the viewpoint of the wire-holding.

The wire press-connecting portion 3 is continuous with the wire clamping portion 4 through a step portion 28 which is stepped in the direction of the wall thickness. More specifically, the side plate portions 12 of the wire press-connecting portion 3 are continuous and integral with the rear-side thin-wall wire clamping portion 4 through a thin-wall interconnecting portion 29 whose upper half portion is notched or removed. Notches 30 are formed in the upper portion of the interconnecting portion 29, and the interconnecting portion 29, having a height equal to or smaller than that of the side plate portions 12 of the wire press-connecting portion 3, is continuous and integral with side plate portions 31 of the wire clamping portion 4. A bottom plate portion 32 (FIG. 2) of the interconnecting portion 29 is thin, and is continuous and integral with the bottom plate portion 26 of the wire clamping portion 4 having the same thickness as that of the bottom plate portion 32.

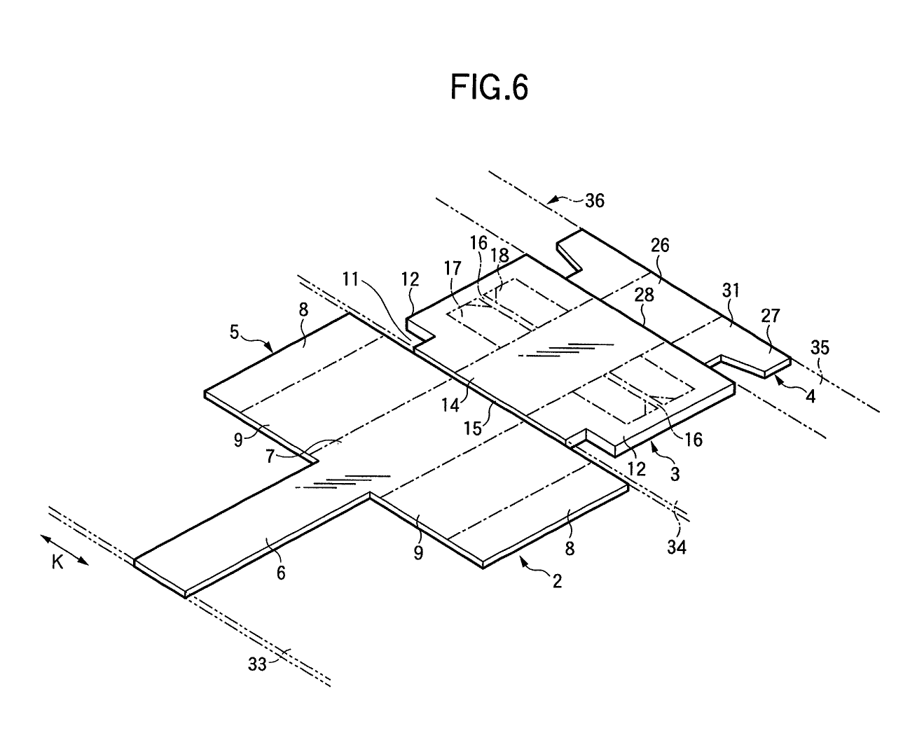

FIG. 6 is a developed view showing one method of producing the press-connecting terminal 1.

In this producing method, the press-connecting terminal 1 is formed by blanking (by a punch and a die) and bending (by shaping dies) a single electrically-conductive metal sheet 36 (having different cross-sections) including a thin sheet portion 33, corresponding to the electrical contact portion 2, a thick sheet portion 34, corresponding to the wire press-connecting portion 3, and a thin sheet portion 35 corresponding to the wire clamping portion 4, these sheet portions 33, 34 and 35 being arranged in a juxtaposed manner.

The step portions 15 and 28 are formed in an upper surface (inner side with respect to the direction of bending of the press-connecting terminal 1) of the electrically-conductive metal sheet 36, and are disposed at the front and rear ends of the wire press-connecting portion 3, respectively, and the lower surface (outer side with respect to the bending direction) of this electrically-conductive metal sheet 36 is flat, and this flat surface serves as a reference surface for the blanking and bending operations. A plurality of press-connecting terminals 1 are formed in a juxtaposed manner in a direction (direction K) of extending of each sheet portion 33, 34, 35 of the single electrically-conductive metal sheet 36 having the different cross-sections. Namely, a plurality of electrical contact portions 2 are formed on the front thin sheet portion 33 in a juxtaposed manner in its longitudinal direction, and a plurality of wire press-connecting portions 3 are formed on the intermediate thick sheet portion 34 in a juxtaposed manner in its longitudinal direction, and a plurality of wire clamping portions 4 are formed on the rear thin sheet portion 35 in a juxtaposed manner in its longitudinal direction.

For example, the electrically-conductive metal sheet is cut by blanking in such a manner that the rear end of the bottom plate portion 26 of each wire clamping portion 4 is connected by a short connecting piece portion (not shown) to a linkage strip extending in a direction (the direction of extending of each sheet portion, that is, the direction K) perpendicular to each terminal (The connecting piece portion and the linkage strip are part of the electrically-conductive metal sheet 36). Then, the plurality of press-connecting terminals 1 are formed or shaped in such a manner that these terminals 1 are connected by the respective connecting piece portions to the single linkage strip, and these press-connecting terminals 1, laterally connected together, is wound on a reel, and the press-connecting terminals 1, thus wound on the reel, are supplied to an automatic inserting machine (not shown), and are mounted in terminal receiving chambers or terminal receiving grooves of a connector housing (not shown) made of a synthetic resin. The connecting piece portions are cut off simultaneously with this mounting operation or simultaneously when the press-connection of the wire 20 and the press-clamping of the wire 20 are effected. In this case, each connecting piece portion is formed by the thin sheet portion 35, and therefore has the same thickness as that of the wire clamping portion 4. Therefore, the connecting piece portion can be easily and positively cut off, and a cutter (not shown) is less damage.

In the condition shown in FIG. 6, the resilient contact piece portion 6 of the electrical contact portion 2 is rearwardly bent into a curved shape. The window portions 16 are formed respectively in the side plate portions 12 of the wire press-connecting portion 3 by stamping, and front and rear portions of this stamped portion of each side plate portion 12, corresponding to the window portion 16, are bent perpendicularly to form the press-connecting piece portions 17 and 18, respectively.

After the resilient contact piece portion 6 is bent into the predetermined shape, the opposite side plate portions 9 of the peripheral wall 5 are bent upwardly perpendicularly, and distal end portions of these bent portions are further bent horizontally to form the top plate portion 8. The convex contact portion 8a (FIG. 1) on the top plate portion 8 is formed by pressing simultaneously when the terminal is blanked. The top plate portion 8 can be formed by the two plate portions joined together at the centerline thereof as in this embodiment, and alternatively the top plate portion 8 can be formed by one plate portion joined to one side plate portion 9.

Simultaneously when the side plate portions 9 of the electrical contact portion 2 are bent, the side plate portions 12 of the wire press-connecting portion 3, as well as the side plate portions 31 and clamping piece portions 27 of the wire clamping portion 42, are bent upwardly perpendicularly. In some cases, the clamping piece portions 27 are bent not perpendicularly but in a slightly outwardly-opened condition.

By the above steps, the press-connecting terminal 1, having the electrical contact portion 2 and the wire clamping portion 4, is formed.

In the case where the wire clamping portion 4 is not provided, there is used an electrically-conductive metal sheet (having different cross-sections) including at least the thin sheet portion 33, corresponding to the electrical contact portions 2, and the thick sheet portion 34 corresponding to the wire press-connecting portions 3.

In the case where a plate-like male tab portion (not shown) is formed as the electrical contact portion, there is used an electrically-conductive metal sheet (having different cross-sections) in which the thick sheet portion 34, corresponding to the wire press-connecting portion 3, is continuous with a thin or thick sheet portion corresponding to the male tab portion. It is not particularly necessary to make the male tab portion thin, and in the case where a box-like portion (used, for example, for retaining the press-connecting terminal 1 by an elastic retaining lance in a connector housing), extending from the male tab portion, is formed by a thin sheet portion, the formation of the box-like portion by bending can be easily effected. In this case, there is used an electrically-conductive metal sheet (having different cross-sections) including a thick sheet portion, corresponding to the male tab portion, a thin sheet portion, corresponding to the box-like portion, and the thick sheet portion 34 corresponding to the wire press-connecting portion 3, these three sheet portions being continuous with one another.

In the case of forming a press-connecting terminal for a joint plate which terminal is bent at an angle of 90 degrees, the notches 11, shown in FIG. 6, are formed deep to reach the bottom plate portion 14, and after each press-connecting terminal in a developed form is blanked from the electrically-conductive metal sheet 36, the electrical contact portion 2 is bent perpendicularly to the wire press-connecting portion 3, and the electrical contact portion 2 and the wire press-connecting portion are bent into their respective shapes separately.

In the case of forming a pair of generally spectacles-like resilient contact piece portions as a female electrical contact portion, those portions (each designated at 8 and 9) of the thin sheet portion 33, disposed respectively at opposite sides of the bottom plate portion 7, are inwardly curled to assume a generally spectacles-shape.

As described above, in the embodiment, the wall thickness of the wire press-connecting portion is larger than the wall thickness of the electrical contact portion. Therefore, the rigidity of the wire press-connecting portion increases, and the wire can be press-connected to the wire press-connecting portion with a high contact load, and besides even when a large pulling force acts on the wire, the deformation of the wire press-connecting portion, as well as the disengagement of the wire, will not occur, and therefore the reliability of press-connection of the wire is enhance.

Since the wall thickness of the electrical contact portion is smaller than the wall thickness of the wire press-connecting portion, the load of insertion of the mating terminal into the electrical contact portion is reduced, while assuring the proper contact load, so that the connecting operation can be easily effected. Since the electrical contact portion has the reduced wall thickness, this electrical contact portion can be formed into a small-size design, and besides the efficiency of the bending operation is enhanced.

In the embodiment, the resilient contact piece portion is smaller in thickness than the wire press-connecting portion, and the force of insertion of the mating terminal, disposed in sliding contact with this resilient contact piece portion, is reduced. The electrical contact portion has the compact outer shape since its bottom plate portion and peripheral wall are smaller in thickness than the wire press-connecting portion. The width of the wire press-connecting portion can be made equal to the width of the electrical contact portion, and therefore the thick wire press-connecting portion can be formed into a compact size, so that the whole of the press-connecting terminal can be formed into a compact design. And besides, the efficiency of the bending operation of the resilient contact piece portion, as well as the efficiency of the bending operation of the peripheral wall, is enhanced, and therefore the processing of the electrical contact portion of a complicated shape can be effected easily and highly precisely.

In the embodiment, the side plate portions and bottom plate portion of the wire press-connecting portion are larger in thickness than the electrical contact portion, and each intersection portion, at which the corresponding side plate portion and the bottom plate portion intersect each other, is also thickened, so that the rigidity of the side plate portions is high. Therefore, when the wire is press-fitted into the gap between at lease one pair of press-connecting piece portions, the two side plate portions are not opened outwardly, so that the press-connecting piece portions positively contact the conductor portion of the wire with a large contact load.

The press-connecting piece portions are larger in thickness than the electrical contact portion, and each intersecting portion, at which the corresponding press-connecting piece portion and the side plate portion intersect each other, is also thickened, and therefore the rigidity of each press-connecting piece portion is high. Therefore, when the wire is press-fitted into the gap between the press-connecting piece portions, these press-connecting piece portions positively cut the insulating sheath of the wire, and firmly holds the wire therebetween with a large force. Thus, at least one pair of press-connecting piece portions are held in firm contact with the conductor portion of the wire, thereby achieving the positive electrical connection. And besides, when a large pulling force acts on the wire, the press-connecting piece portions positively hold the wire, thereby preventing the withdrawal of the wire. Thanks to these effects, the reliability of the electrical connection is enhanced.

In the embodiment, the wire clamping portion is thin while the wire press-connecting portion is thick, and therefore with a small force, the wire clamping portion can be easily pressed to clamp the wire while keeping the enhanced press-connecting ability of the wire press-connecting portion. And besides, the height of the thus pressed wire clamping portion is kept to a low level, and the press-connecting terminals can be received in the connector housing in a compact manner, so that the connector itself can be formed into a compact size.

Because of the provision of the thick wire press-connecting portion, the reliability of press-connection of the wire is enhanced, and because of the provision of the thin electrical contact portion, the efficiency of insertion of the mating terminal and the efficiency and precision of the processing of the electrical contact portion are enhanced, and besides the compact design is achieved, and further because of the provision of the thin wire clamping portion, the efficiency and precision of the wire clamping operation are enhanced, and besides the compact design is achieved. Furthermore, the press-connecting portion firmly holds the wire, and therefore the wire clamping portion need only to achieve an auxiliary function, and even the thin wire clamping portion provides the sufficient wire holding force.

In the embodiment, the bottom plate portion of the wire clamping portion is smaller in thickness than the wire press-connecting portion, and the height of the wire, placed on this bottom plate portion, is kept to a low level, and therefore the height of the pressed wire clamping portion is kept to a low level. And besides, the wire clamping operation can be effected with a small force since the clamping piece portions are smaller in thickness than the wire press-connecting portion, and therefore the efficiency and precision of the wire clamping operation are enhanced. The press-connecting portion firmly holds the wire, and therefore the wire clamping portion need only to achieve the auxiliary function, and even the thin wire clamping portion provides the sufficient wire holding force.

It is contemplated that numerous modifications may be made to the press-connecting terminal of the present invention without departing from the spirit and scope of the invention as defined in the following claims.

What is claimed is:

1. A press-connecting terminal, comprising:
a wire press-connecting portion to which a wire is connectable; and
an electrical contact portion, to which a mating terminal is connectable, integrally formed with a first end of the wire press-connecting portion,
wherein a wall thickness of the wire press-connecting portion is greater than a wall thickness of the electrical contact portion.

2. The press-connecting terminal of claim 1, wherein the electrical contact portion includes:
a thin bottom plate portion,
a thin peripheral wall portion integrally formed with the thin bottom plate portion, and
a thin resilient contact piece portion which is disposed within the thin peripheral wall portion, and is integrally formed with the thin bottom plate portion.

3. The press-connecting terminal of claim 1, wherein the wire press-connecting portion includes:
a thick bottom plate portion,
thick side plate portions respectively extending upwardly from opposite side edges of the thick bottom plate portion, and
thick press-connecting piece portions respectively projecting inwardly from edges of window portions, which are respectively formed through the thick side plate portions.

4. The press-connecting terminal of claim 2, wherein the wire press-connecting portion includes:
a thick bottom plate portion,
thick side plate portions respectively extending upwardly from opposite side edges of the thick bottom plate portion, and
thick press-connecting piece portions respectively projecting inwardly from edges of window portions, which are respectively formed through the thick side plate portions.

5. The press-connecting terminal of claim 1, further comprising:
a wire clamping portion integrally formed with a second end of the wire press-connecting portion remotely from the electrical contact portion,
wherein the wall thickness of the wire press-connecting portion is greater than a wall thickness of the wire clamping portion.

6. The press-connecting terminal of claim 2, further comprising:
a wire clamping portion integrally formed with a second end of the wire press-connecting portion remotely from the electrical contact portion,
wherein the wall thickness of the wire press-connecting portion is greater than a wall thickness of the wire clamping portion.

7. The press-connecting terminal of claim 3, further comprising:
a wire clamping portion integrally formed with a second end of the wire press-connecting portion remotely from the electrical contact portion,
wherein the wall thickness of the wire press-connecting portion is greater than a wall thickness of the wire clamping portion.

8. The press-connecting terminal of claim 4, further comprising:
a wire clamping portion integrally formed with a second end of the wire press-connecting portion remotely from the electrical contact portion,
wherein the wall thickness of the wire press-connecting portion is greater than a wall thickness of the wire clamping portion.

9. The press-connecting terminal of claim 5, wherein the wire clamping portion includes:
a thin bottom plate portion, and
thin clamping piece portions respectively extending upwardly from opposite side edges of the thin bottom plate portion.

10. The press-connecting terminal of claim 6, wherein the wire clamping portion includes:
a thin bottom plate portion, and
thin clamping piece portions respectively extending upwardly from opposite side edges of the thin bottom plate portion.

11. The press-connecting terminal of claim 7, wherein the wire clamping portion includes:
a thin bottom plate portion, and
thin clamping piece portions respectively extending upwardly from opposite side edges of the thin bottom plate portion.

12. The press-connecting terminal of claim 8, wherein the wire clamping portion includes:
a thin bottom plate portion, and
thin clamping piece portions respectively extending upwardly from opposite side edges of the thin bottom plate portion.
